(19) United States
(12) Patent Application Publication
(10) Pub. No.: US 2025/0317208 A1
(43) Pub. Date: Oct. 9, 2025

(54) HOST DEVICE AND OPTICAL MODULE EQUALIZATION

(71) Applicant: Cisco Technology, Inc., San Jose, CA (US)

(72) Inventor: Antonio CARUGATI, Lissone (IT)

(21) Appl. No.: 19/078,169

(22) Filed: Mar. 12, 2025

Related U.S. Application Data
(60) Provisional application No. 63/574,095, filed on Apr. 3, 2024.

(51) Int. Cl. H04B 10/294; H04B 10/69

(52) U.S. Cl. CPC H04B 10/2941; H04B 10/6971

(57) ABSTRACT

The present disclosure describes an optical system that accounts for insertion loss of ports. According to an embodiment, the system includes an optical module and a host device. The optical module includes a memory that stores a table that includes a first pre-equalizer parameter for a first insertion loss. The host device includes a port, a pre-equalizer, a memory, and a processor communicatively coupled to the memory. The port receives the optical module. The memory stores a second pre-equalizer parameter for the pre-equalizer. The processor performs an operation that includes retrieving, based on an insertion loss of the port and the first insertion loss, a portion of the table that includes the first pre-equalizer parameter, determining a convolution of the second pre-equalizer parameter with the first pre-equalizer parameter, and adjusting the pre-equalizer based on the convolution.

### CROSS-REFERENCE TO RELATED APPLICATIONS

This application claims benefit of co-pending U.S. provisional patent application Ser. No. 63/574,095 filed Apr. 3, 2024. The aforementioned related patent application is herein incorporated by reference in its entirety.

### TECHNICAL FIELD

Embodiments presented in this disclosure generally relate to optical devices. More specifically, embodiments disclosed herein relate to an equalization process for a host device and optical module.

### BACKGROUND

Optical modules may be plugged into host devices to convert electrical signals from the host devices into optical signals. In some instances, the host devices may perform equalization (e.g., pre-equalization) on the electrical signals to compensate for distortions that may be introduced into the electrical signals.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIGS. 2A and 2B illustrate example tables in the system of FIG. 1.

FIG. 3 illustrates an example operation performed by the system of FIG. 1.

FIG. 4 illustrates an example operation performed by the system of FIG. 1.

FIG. 5 is a flowchart of an example method performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an optical system that accounts for insertion loss of ports. According to an embodiment, the system includes an optical module and a host device. The optical module includes a memory that stores a table that includes a first pre-equalizer parameter for a first insertion loss. The host device includes a port, a pre-equalizer, one or more memories, and one or more processors communicatively coupled to the one or more memories. The port receives the optical module. The one or more memories store a second pre-equalizer parameter for the pre-equalizer. The one or more processors, individually or collectively, perform an operation that includes retrieving, based on an insertion loss of the port and the first insertion loss, a portion of the table that includes the first pre-equalizer parameter, determining a convolution of the second pre-equalizer parameter with the first pre-equalizer parameter, and adjusting the pre-equalizer based on the convolution.

According to another embodiment, an optical module includes one or more memories and an interface. The one or more memories, individually or collectively, store a table that includes a first pre-equalizer parameter for a first insertion loss. The interface engages a port of a host device and directs, through the port and based on the first insertion loss, a portion of the table comprising the first pre-equalizer parameter and the first insertion loss such that the host device (i) performs a convolution using the first pre-equalizer parameter and a second pre-equalizer parameter and (ii) adjusts a pre-equalizer of the host device based on the convolution.

According to another embodiment, a host device includes a port, a pre-equalizer, one or more memories, and one or more processors communicatively coupled to the one or more memories. The port receives an optical module. The one or more memories store a first pre-equalizer parameter for the pre-equalizer. The one or more processors, individually or collectively, perform an operation that includes retrieving, from the optical module and based on an insertion loss of the port, a portion of a table that includes a second pre-equalizer parameter, determining a convolution of the first pre-equalizer parameter with the second pre-equalizer parameter, and adjusting the pre-equalizer based on the convolution.

### EXAMPLE EMBODIMENTS

As the capacity delivered by switching chips continue to grow, the power consumption of optical transceivers has begun to exceed that of switching chips, becoming a key factor in network solutions. For example, in some existing switches, optical transceivers may represent 16% or more of the power consumed by the switches under standard operating conditions. The digital signal processor (DSP) in the transceivers, which may be used to overcome optical and electrical impairments in both long and short hauls, may account for around 50% to 70% of the power consumption of the transceiver.

To reduce power consumption and cost while providing high-speed, high-density optical communication connections, linear-drive pluggable optics (LPO) modules have emerged. LPO technology uses a linear drive approach, replacing DSPs with transimpedance amplifiers (TIAs) and drivers (e.g., drive chips) with high linearity. This design significantly reduces power consumption and latency relative to using DSPs.

In existing LPO systems, the functions of the DSP (e.g., equalization, retiming, etc.) are assumed by the switch serializer/deserializer (SerDes), which may be part of the host board, host circuit, or host device into which the LPO module plugs. If the switch SerDes is sufficiently powerful, the LPO could achieve approximately the same performance at the output of the LPO module as optical modules that include a DSP. It may be difficult, however, to ensure that the output of the LPO module complies with standard recommendations to interoperate with other network elements.

For example, a host board, circuit, or device may have many ports that can receive optical modules. Each port has a connection to the main application-specific integrated circuit (ASIC), which includes physical printed circuit board (PCB) traces, with 4 to 16 differential pairs (depending on the port types) per port. The ports that are closer to the center of the board and the ASIC use shorter traces to connect to the ASIC. The ports that are closer to the lateral ends of the board and further away from the ASIC use longer traces to connect to the ASIC.

The physical distance between the ASIC and the traces (e.g., module connectors), the traces themselves, and the DSP package introduce distortion and impairment on the signal paths (e.g., intersymbol Interference and reflections). Optical transceivers with DSPs can compensate for these impairments (e.g., by equalizers synthetized and implemented in ASIC in both host SerDes and optical modules). For example, the equalizers in the DSPs of the optical modules can equalize some of the distortions to produce better signal-to-noise ratios (SNRs), mean square errors (MSEs), or bit error rates (BERs).

On the other hand, existing LPO modules may not compensate for some of these distortions, which results in the LPO modules not interoperating with other network components when the LPO modules are plugged into certain ports on the host device (e.g., the ports near the lateral ends of the board that use longer traces to connect to the ASIC). Generally, the ports near the edge of the board have a higher insertion loss (IL) than the ports near the middle of the board. The IL may cause LPOs that are plugged into the ports near the edge of the board to not function properly.

The present disclosure describes an optical system that uses the host device to perform some of the functions of the digital signal processor (DSP) that is included in existing optical transceivers but not present in a linear-drive pluggable optics (LPO) module. The LPO module may store several insertion loss (IL) profiles. Each profile may indicate equalizer parameters (e.g., coefficients for a certain transmitter equalizer) for a certain IL or for a certain IL range. When the LPO is plugged into a certain port, the host device determines the port and the IL of that port. The host device may know the IL of the port from prior testing or operation. The host device then retrieves the IL profile for the IL of the port and sets the parameters (e.g., coefficients) for the equalizer (e.g., a pre-equalizer) in the host device (e.g., in the SerDes) using the parameters from the IL profile (e.g., by a convolution operation involving the parameters for the equalizer and the parameters in the IL profile). As a result, the equalizer in the host device may effectively perform some of the equalizer functions of the missing DSP.

In some embodiments, the optical system provides several technical advantages. For example, the optical system may equalize distortions arising from the IL of the port to produce better signal-to-noise ratios (SNRs), mean square errors (MSEs), or bit error rates (BERs). As another example, the optical system may allow the LPO module to interoperate with other network components.

The optical system allows a smooth integration of LPO modules into optical networks and ecosystems. Based on data exchanged between a host device and a LPO module, the system configures itself so that the LPO is interoperable with other LPOs and other DSP based pluggables in any ports, even in different host platforms. The data may be exchanged through a communication channel between a processor on the host device and the processor or controller and memory in the LPO module. The data may be exchanged during the bring up of the link or at runtime (e.g., configuration and monitoring).

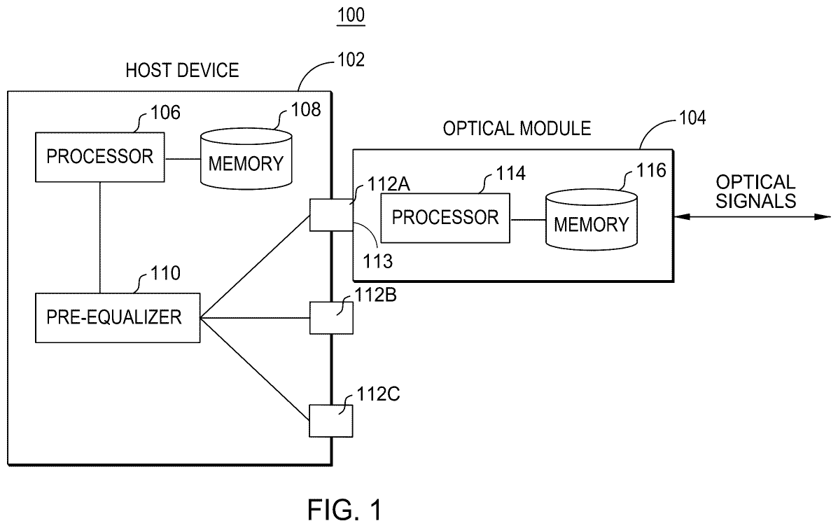

FIG. 1 illustrates an example system 100. As seen in FIG. 1, the system 100 includes a host device 102 and an optical module 104. Generally, the optical module 104 stores a data structure (e.g., a table, an array, a matrix, etc.) that includes pre-equalizer parameters (e.g., tap coefficients, tap weights, etc.) for different ILs or IL ranges. When the optical module 104 is plugged into a port of the host device 102, the host device 102 may retrieve a portion of the data structure that includes a pre-equalizer parameter for the IL of the port. The host device 102 may then use the pre-equalizer parameter to adjust the pre-equalizer in the host device 102. In this manner, the host device 102 accounts for the IL of the port when performing equalization.

In the example of FIG. 1, the host device 102 includes a processor 106, a memory 108, a pre-equalizer 110, and one or more ports 112. Generally, the processor 106 and the memory 108 perform the actions or functions of the host device 102 described herein.

The processor 106 is any electronic circuitry, including, but not limited to one or a combination of microprocessors, microcontrollers, application specific integrated circuits (ASIC), application specific instruction set processor (ASIP), and/or state machines, that communicatively couples to the memory 108 and controls the operation of the host device 102. The processor 106 may be 8-bit, 16-bit, 32-bit, 64-bit or of any other suitable architecture. The processor 106 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 106 may include other hardware that operates software to control and process information. The processor 106 executes software stored on the memory 108 to perform any of the functions described herein. The processor 106 controls the operation and administration of the host device 102 by processing information (e.g., information received from the optical module 104 and memory 108). The processor 106 is not limited to a single processing device and may encompass multiple processing devices contained in the same device or computer or distributed across multiple devices or computers. The processor 106 is considered to perform a set of functions or actions if the multiple processing devices collectively perform the set of functions or actions, even if different processing devices perform different functions or actions in the set.

The memory 108 may store, either permanently or temporarily, data, operational software, or other information for the processor 106. The memory 108 may include any one or a combination of volatile or non-volatile local or remote devices suitable for storing information. For example, the memory 108 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 108, a disk, a CD, or a flash drive. In particular embodiments, the software may include an application executable by the processor 106 to perform one or more of the functions described herein. The memory 108 is not limited to a single memory and may encompass multiple memories contained in the same device or computer or distributed across multiple devices or computers. The memory 108 is considered to store a set of data, operational software, or information if the multiple memories collectively store the set of data, operational software, or information, even if different memories store different portions of the data, operational software, or information in the set.

Generally, the host device 102 may generate and communicate an electrical signal to the optical module 104, and/or the host device 102 may receive an electrical signal from the optical module 104. The host device 102 may use the pre-equalizer 110 to adjust the electrical signal to compensate for distortions that other parts of the system 100 may introduce into the electrical signal. For example, the pre-equalizer 110 may adjust the electrical signal to account for distortions introduced by IL of the ports 112.

The host device 102 may include any number of ports 112. In the example of FIG. 1, the host device 102 includes the ports 112A, 112B, and 112C. Each port 112A, 112B, and 112C may be located in different parts of the host device 102, and thus, each port 112A, 112B, and 112C may be a different distance from the pre-equalizer 110 and/or the processor 106. As a result, each port 112A, 112B, and 112C may present a different IL (e.g., due to the different lengths of electrical traces used to connect the ports 112A, 112B, and 112C to the pre-equalizer 110 and/or the processor 106). Thus, the pre-equalizer 110 may adjust signals from the different ports 112A, 112B, and 112C differently to account for the different ILs of the ports 112A, 112B, and 112C.

The optical module 104 may be an LPO and may plug into any of the ports 112A, 112B, and 112C. For example, the optical module 104 may include an interface 113 that engages (e.g., plugs into) one of the ports 112A, 112B, or 112C to form an electrical connection with the host device 102. The optical module 104 may then convert electrical signals from the host device 102 into optical signals, and vice versa. For example, the optical module 104 may convert electrical signals from the host device 102 into optical signals. The optical module 104 may then direct the optical signals to another optical component. As another example, the optical module 104 may receive optical signals and convert the optical signals into electrical signals. The optical module 104 may then direct the electrical signals to the host device 102 through a port 112.

As seen in FIG. 1, the optical module includes a processor 114 and a memory 116, which may perform the functions or actions of the optical module described herein. The optical module 104 uses the memory 116 to store IL profiles that indicate pre-equalizer parameters for different ILs or IL ranges. For example, the memory 116 may store a data structure (e.g., a table, array, matrix, etc.) that includes entries. Each entry may indicate an IL or IL range. Additionally, each entry may indicate a pre-equalizer parameter for the IL or IL range. These entries may be determined through testing or simulations and may be stored into the memory 116.

The processor 114 is any electronic circuitry, including, but not limited to one or a combination of microprocessors, microcontrollers, application specific integrated circuits (ASIC), application specific instruction set processor (ASIP), and/or state machines, that communicatively couples to the memory 116 and controls the operation of the optical module 104. The processor 114 may be 8-bit, 16-bit, 32-bit, 64-bit or of any other suitable architecture. The processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 114 may include other hardware that operates software to control and process information. The processor 114 executes software stored on the memory 116 to perform any of the functions described herein. The processor 114 controls the operation and administration of the optical module 104 by processing information (e.g., information received from the host device 102 and memory 116). The processor 114 is not limited to a single processing device and may encompass multiple processing devices contained in the same device or computer or distributed across multiple devices or computers. The processor 114 is considered to perform a set of functions or actions if the multiple processing devices collectively perform the set of functions or actions, even if different processing devices perform different functions or actions in the set.

The memory 116 may store, either permanently or temporarily, data, operational software, or other information for the processor 114. The memory 116 may include any one or a combination of volatile or non-volatile local or remote devices suitable for storing information. For example, the memory 116 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 116, a disk, a CD, or a flash drive. In particular embodiments, the software may include an application executable by the processor 114 to perform one or more of the functions described herein. The memory 116 is not limited to a single memory and may encompass multiple memories contained in the same device or computer or distributed across multiple devices or computers. The memory 116 is considered to store a set of data, operational software, or information if the multiple memories collectively store the set of data, operational software, or information, even if different memories store different portions of the data, operational software, or information in the set.

When the optical module 104 is plugged into a port 112 of the host device 102 (e.g., using the interface 113), the host device 102 may determine into which port 112 the optical module 104 is plugged and the IL of the port 112. The host device 102 may then retrieve, from the memory 116, a portion of the data structure for the IL of the port 112 (e.g., through the interface 113 plugged into the port 112). For example, if the data structure indicates pre-equalizer parameters for different ILs, then the host device 102 may retrieve a portion of the data structure that indicates ILs within a threshold of the IL of the port 112. As another example, if the data structure indicates pre-equalizer parameters for different IL ranges, then the host device may retrieve a portion of the data structure that indicates an IL range that contains the IL of the port 112. The host device 102 then uses the pre-equalizer parameter in the retrieved portion of the data structure to adjust the pre-equalizer 110. For example, the host device 102 may perform a convolution using the pre-equalizer parameter from the data structure and another pre-equalizer parameter (e.g., stored in the memory 108). The host device 102 then adjusts the pre-equalizer 110 using the convolution of the pre-equalizer parameters. In this manner, the host device 102 adjusts the pre-equalizer 110 to compensate for distortions introduced by the IL of the port 112.

In the example of FIG. 1, the optical module 104 is plugged into the port 112A. The host device 102 may determine that the optical module 104 is plugged into the port 112A and then determine the IL of the port 112A. The host device 102 may then retrieve, from the memory 116 in the optical module 104 (e.g., through the interface 113 plugged into the port 112A), the portion of the data structure that indicates an IL within a threshold of the IL of the port 112A or an IL range that contains the IL of the port 112A. In some embodiments, the portion of the data structure retrieved by the host device 102 may indicates ILs outside the threshold or IL ranges that do not contains the IL of the port 112A. For example, the host device 102 may retrieve the entire data structure. The optical module 104 and/or the interface 113 may direct the portion of the data structure to the host device 102 through the port 112A.

The host device 102 may then determine the pre-equalizer parameter in the data structure that corresponds to the IL within the threshold of the IL of the port 112A or that corresponds to the IL range that contains the IL of the port 112A. The host device 102 then performs a convolution of the pre-equalizer parameter from the data structure and another pre-equalizer parameter stored in the memory 108. The host device 102 then adjusts the pre-equalizer 110 using the convolution of these pre-equalizer parameters. In this manner, the host device 102 adjusts the pre-equalizer 110 so that the pre-equalizer 110 compensates for the IL of the port 112A.

As another example operation, during the design and validation of the host device 102, a set of pre-equalizer parameters (e.g., taps coefficients) may be defined or set for each port 112 to assure that the ports 112 operate in compliance with the relevant standardization. The parameters may depend on the number of taps in the pre-equalizer 110. This number may be design related and not normalized by an industry standard.

1. During the design stage of the optical module 104, optically couple a standard reference transmitter with a certain number of taps of the pre-equalizer 110 to the optical module 104. This reference transmitter can be designed according to IEEE documentation (e.g., 802.3).

2. A set of pre-equalizer parameters (e.g., taps coefficients) may be determined using the reference transmitters. These parameters may be determined using multiple IL profiles interposed between the reference transmitter and the optical module 104. These sets of parameters may optimize the performance at an output of the optical module 104 (e.g., in terms of transmitter and dispersion eye closure quaternary (TDECQ), SNR, MSE, or BER). As a result, the response of the sets of parameters may compensate the channel impairments. In some instances, the signal at the output of the optical module 104 may be post-processed (e.g., by math feature in a digital communication analyzer (DCA)) by an adaptive feed-forward equalizer (FFE). The outcome parameters correspond, in the time domain, to the reverse of the whole channel response.

3. The optical module 104 may have multiple settings parameters to apply to the optical module 104 to achieve the best performance according to the IL profiles.

4. The optical module 104 may provide a suitable lookup table in which the pre-equalizer parameters are stored or referenced. These parameters may be applied to the reference transmitter with the different IL profiles.

5. When the optical module 104 is plugged into the host device 102, the processor 106 of the host device 102 fetches from the optical module 104, via a communication channel, the pre-equalizer parameters of the IL profile corresponding to the IL of the port 112 used.

6. The number of taps of the reference transmitter and the number of taps in the pre-equalizer 110 of the host device 102 may not be equal. Moreover, the pre-equalizer 110 of the host device 102 may have a set of parameters to compensate the IL on the port 112.

7. The set of parameters fetched from the optical module 104 may not be directly loaded into the pre-equalizer 110 of the host device 102. The processor 106 of the host device 102 may calculate the convolution of the set of pre-equalizer parameters of the host device 102 with the set of parameters fetched from the optical module 104 to produce the set of parameters to be loaded into the pre-equalizer 110 of the host device 102. The convolution may be determined prior to being normalized on the unit value. The convolution result may be the vector of coefficients that equalizes the whole transmission channel, including all impairments and losses on the printed circuit board (PCB). The package, connector, PCB on the optical module 104, analog front end (AFE) of the optical module 104 may also be compensated. It may be the case that, due to the fact that the host board has already compensated part of the IL corresponding to the PCB card, these IL portions may be de-embedded, leaving only impairments (e.g., the impairments due to the package, the connector, etc.).

8. The set of taps applied to the pre-equalizer 110 may restore the quality of the signal at the output of the optical module 104 as prior calibrated in the optical module 104 with the IL profile chosen and a reference transmitter. According to the design of the pre-equalizer 110 of the host device 102, the array may be normalized based on the digital full scale allowed (e.g., digital quantization), and pick up the numbers of values according to the number of pre-equalizer taps implemented on the transmission side. These values may be applied to the pre-equalizer 110 and may provide compliance at the optical module 104 output. The signal at the output of the optical module 104, post-proceed by an adaptive FFE or linear equalizer may have all taps near zero (e.g., Dirac pulse).

9. After this optimization stage in the host device 102, a further improvement may be applied to the optical module 104. The IL profiles of the optical module 104 may also provide internal settings for the optical module 104. The optical module 104 may apply these settings (e.g., settings related to laser bias current, continuous time linear equalization (CTLE) bandwidth (BW) and gains, etc.) to provide improved performance for every IL profile selected. As a result, the host device 102 may indicate to the optical module 104 (e.g., via the communication channel) which IL profile corresponds to the port used by the optical module 104, and the optical module 104 configures itself accordingly using the settings for the IL profile. For the receiver path, due to the fact that the digital equalizers on the host device 102 are adaptive, the optimization of the optical module 104 in the receiver side may need be configured according to the settings in the IL profile in the receiver side optical module. The receiver side may not determine a set of parameters for the optical module 104 and the host device 102 on the receiver side.

An example of the convolution is as follows: For a sequence x[n] representing the input signal and a sequence h[n] representing the channel response, the convolution x[n] by h[n] produces the output sequence y[n].

$$y [ n ] = {h [ n ]}^{*} x [ n ] ( {where}^{*} indicates a convolution ) = {\sum }_{k} h [ k ] x [ n - k ] ↔ H ( z ) X ( z ) \qquad ( 1 )$$

$$C ( z ) = 1 / H ( z ) = {H}^{- 1} ( z )$$

$${c [ n ]}^{*} y [ n ] = {\sum }_{k} c [ k ] y [ n - k ] ↔ C ( z ) Y ( z ) = {H}^{- 1} ( z ) Y ( z ) = {H}^{- 1} ( z ) H ( z ) X ( z ) = X ( z )$$

Contextualizing for the optical system, the parameters of the adaptive linear equalizer may be the elements of C(z). By construction, the linear adaptive equalizer returns a response able to cancel the channel effects (e.g., the zero-forcing method). In this condition, by equation (1), the output response will be a Dirac delta in the time domain and flat as a frequency response.

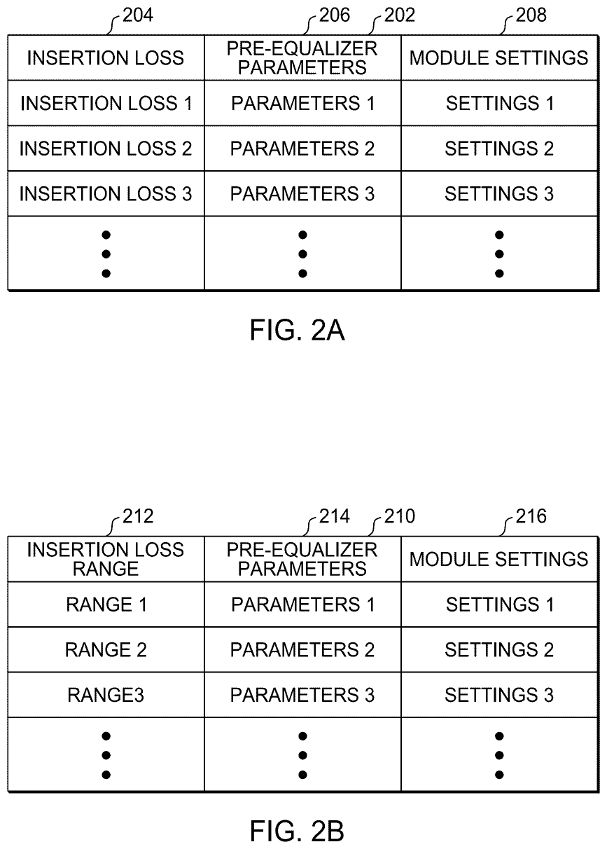

FIGS. 2A and 2B illustrate example data structures in the system 100 of FIG. 1. Generally, the data structures shown in the examples of FIGS. 2A and 2B are tables, but the data structures may have any suitable structure or form (e.g., arrays, lists, matrices, etc.). The data structures include parameters and settings for different ILs or IL ranges. An optical module (e.g., the optical module 104 shown in FIG. 1) may store the data structures, and the data structures may be retrieved by a host device (e.g., the host device 102 shown in FIG. 1) into which the optical module is plugged.

FIG. 2A shows a table 202 that includes columns 204, 206, and 208. The column 204 includes IL values. The column 206 includes pre-equalizer parameter values. The column 208 includes module setting values. When the host device determines the IL of a port into which the optical module is plugged, the host device may retrieve a portion of the table 202 (or the entire table 202). The host device may then determine the IL in the column 204 that matches the IL of the port or that is within a threshold of the IL of the port. The host device then determines the pre-equalizer parameter from the column 206 that corresponds to the determined IL in the column 204. The host device then adjusts the pre-equalizer of the host device using the pre-equalizer parameter from the column 206. As an example, the host device may determine that the IL of the port matches or is within the threshold of Insertion Loss 2 in the column 204. Consequently, the host device may then use Parameters 2 in the column 206 to adjust the pre-equalizer of the host device.

In some embodiments, the host device communicates a message to the optical module indicating the IL from the column 204 used by the host device. The optical module may then determine the module setting from the column 208 that corresponds to the IL from the column 204. The optical module may then apply the module setting to the optical module. Using the previous example, the host device may communicate a message to the optical module indicating that the host device used Insertion Loss 2 from the column 204. The optical module may then select Settings 2 from the column 208 and apply Settings 2 to the optical module. Settings 2 may include settings related to laser bias current, continuous time linear equalization (CTLE) bandwidth (BW) and gains, etc. In this manner, the optical module may apply settings based on the IL at the port.

FIG. 2B shows a table 210 that includes columns 212, 214, and 216. The column 212 includes IL ranges. The column 214 includes pre-equalizer parameter values. The column 216 includes module setting values. When the host device determines the IL of a port into which the optical module is plugged, the host device may retrieve a portion of the table 210 (or the entire table 210). The host device may then determine the IL range in the column 212 that contains the IL of the port. The host device then determines the pre-equalizer parameter from the column 214 that corresponds to the determined IL range in the column 212. The host device then adjusts the pre-equalizer of the host device using the pre-equalizer parameter from the column 214. As an example, the host device may determine that the IL of the port is within Range 1 in the column 212. Consequently, the host device may then use Parameters 1 in the column 214 to adjust the pre-equalizer of the host device.

In some embodiments, the host device communicates a message to the optical module indicating the IL range from the column 212 used by the host device. The optical module may then determine the module setting from the column 216 that corresponds to the IL range from the column 212. The optical module may then apply the module setting to the optical module. Using the previous example, the host device may communicate a message to the optical module indicating that the host device used Range 1 from the column 212. The optical module may then select Settings 1 from the column 216 and apply Settings 1 to the optical module. Settings 1 may include settings related to laser bias current, continuous time linear equalization (CTLE) bandwidth (BW) and gains, etc. In this manner, the optical module may apply settings based on the IL at the port.

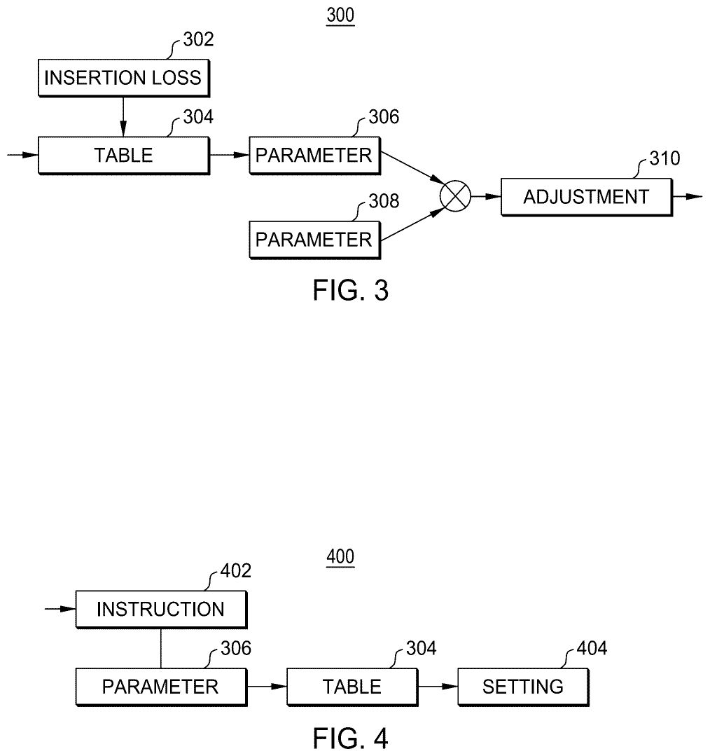

FIG. 3 illustrates an example operation 300 performed by the system 100 of FIG. 1. Generally, a host device (e.g., the host device 102 shown in FIG. 1) may perform the operation 300. By performing the operation 300, the host device may adjust a pre-equalizer of the host device to compensate for an IL at a port into which an optical module (e.g., the optical module 104 shown in FIG. 1) is plugged.

The host device begins by determining an IL 302 of the port into which the optical module is plugged. For example, the host device may measure the IL 302 of the port. As another example, the IL 302 may have been previously measured or determined and stored in a data structure or table in the host device. The host device may reference the data structure or table to determine the IL 302 of the port.

The host device may retrieve a table 304 from the optical module. The table 304 may be stored in the optical module. The host device may retrieve a portion of the table 304, which may include some or all of the table 304. The table 304 may include IL values or IL ranges. If the table 304 indicates IL values, then the host device may determine one or more IL values in the table 304 that match and/or are within a threshold of the IL 302. If the table 304 indicates IL ranges, then the host device may determine one or more IL ranges in the table 304 that contain the IL 302.

The host device may then determine one or more pre-equalizer parameters 306 in the table 304 that correspond to the determined IL values or the IL ranges. As an example, these pre-equalizer parameters 306 may be tap weights or tap coefficients. In instances where the host device determines multiple pre-equalizer parameters 306 from the table, the host device may combine these pre-equalizer parameters 306 (e.g., using an average or weighted average of the pre-equalizer parameters 306). The host device may then perform a convolution of the pre-equalizer parameters 306 with one or more pre-equalizer parameters 308 stored in the host device to produce an adjustment 310. The pre-equalizer parameters 308 may have been determined previously for use by the host device. The pre-equalizer parameters 308, however, may not compensate or may not fully compensate for the IL 302 of the port. By performing the convolution of the pre-equalizer parameters 306 with the pre-equalizer parameters 308, the adjustment 310 may compensate for the IL 302 of the port. After generating the adjustment 310, the host device applies the adjustment 310 to the pre-equalizer. For example, the host device may adjust the tap coefficients or tap weights of the pre-equalizer according to the adjustment 310. In this manner, the pre-equalizer is adjusted to compensate for the IL 302 of the port.

FIG. 4 illustrates an example operation 400 performed by the system 100 of FIG. 1. Generally, an optical module (e.g., the optical module 104 shown in FIG. 1) performs the operation 400. By performing the operation 400, the optical module 104 adjusts the optical module 104 based on the IL and/or pre-equalizer parameters selected by a host device (e.g., the host device 102 shown in FIG. 1) from a table stored by the optical module 104 to compensate for an IL of a port of the host device into which the optical module is plugged.

The optical module begins by receiving an instruction 402. The host device may generate and direct the instruction 402 to the optical module after the host device selects the pre-equalizer parameters from the table 304 from the optical module. The instruction 402 may indicate the IL and/or the pre-equalizer parameters 306 that the host device selected from the table 304. The optical module may reference the table 304 using the parameters 306 to determine a setting 404 corresponding to the parameters 306 in the table 304. The optical module may then apply the setting 404 to the optical module. For example, the setting 404 may relate to laser bias current, continuous time linear equalization (CTLE) bandwidth (BW) and gains, etc. In this manner, the optical module adjusts itself based on the IL of the port into which the optical module is plugged.

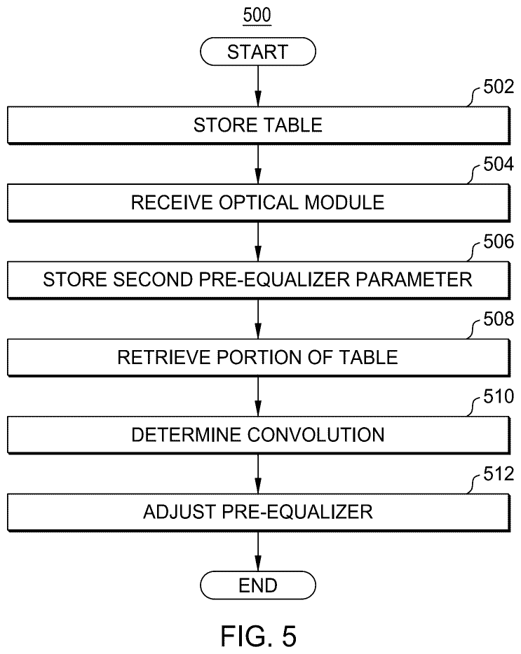

FIG. 5 is a flowchart of an example method 500 performed by the system 100 of FIG. 1. In certain embodiments, various components of the system 100 perform the steps of the method 500. For example, a host device (e.g., the host device 102 shown in FIG. 1) and an optical module (e.g., the optical module 104 shown in FIG. 1) may perform the steps of the method 500. By performing the method 500, the host device adjusts a pre-equalizer of the host device to compensate for IL of a port into which the optical module is plugged.

At 502, the optical module stores a table (e.g., in a memory of the optical module). The table may indicate pre-equalizer parameter values for different ILs or IL ranges. These pre-equalizer parameter values may have been determined through testing or simulation of the optical module. For example, the table may store the value of a first pre-equalizer parameter.

At 504, the host device receives the optical module. For example, the host device may include ports into which the optical module may plug. The optical module may be plugged into one of the ports to form an electrical connection with the host device. Different ports of the host device may be positioned different distances from a processor or pre-equalizer of the host device. As a result, different ports may use electrical traces of different lengths to connect to the processor or pre-equalizer. Consequently, the ports may experience or produce different ILs that distort an electrical signal from the host device differently.

At 506, the host device stores a second pre-equalizer parameter (e.g., in a memory of the host device). The second pre-equalizer parameter may have been determined through testing or simulation of the host device. The second pre-equalizer parameter, however, may not account for the ILs at the port.

At 508, the host device retrieves a portion of the table from the optical module. For example, the host device may determine (e.g., measure) the IL of the port and retrieve a portion of the table that includes ILs that match and/or are within a threshold of the IL of the port. As another example, the host device may retrieve a portion of the table that includes IL ranges that contain the IL of the port. The host device may then determine the first pre-equalizer parameter from the portion of the table corresponding to the IL that matches or is within the threshold of the IL of the port or corresponding to the IL range that contains the IL of the port.

At 510, the host devices determines a convolution of the first pre-equalizer parameter from the table and the second pre-equalizer parameter stored in the host device. The convolution may produce an adjustment that compensates for the IL of the port. At 512, the host device adjusts the pre-equalizer of the port using the convolution. In this manner, the host device adjusts the pre-equalizer so that the pre-equalizer compensates for distortions introduced by the IL of the port.

In summary, the optical system 100 uses the host device 102 to perform some of the functions of the DSP that is included in existing optical transceivers but not present in an LPO module. The LPO module may store several IL profiles. Each profile may indicate equalizer parameters (e.g., coefficients for a certain transmitter equalizer) for a certain IL or for a certain IL range. When the LPO is plugged into a certain port, the host device 102 determines the port and the IL of that port. The host device 102 may know the IL of the port from prior testing or operation. The host device 102 then retrieves the IL profile for the IL of the port and sets the parameters (e.g., coefficients) for the equalizer (e.g., a pre-equalizer) in the host device (e.g., in the SerDes) using the parameters from the IL profile (e.g., by a convolution operation involving the parameters for the equalizer and the parameters in the IL profile). As a result, the equalizer in the host device 102 may effectively perform some of the equalizer functions of the missing DSP.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A system comprising:
an optical module comprising a memory configured to store a table comprising a first pre-equalizer parameter for a first insertion loss; and
a host device comprising:
a port configured to receive the optical module;
a pre-equalizer;
one or more memories configured to store a second pre-equalizer parameter for the pre-equalizer; and
one or more processors communicatively coupled to the one or more memories, wherein the one or more processors are configured to, individually or collectively, perform an operation comprising:
retrieving, based on an insertion loss of the port and the first insertion loss, a portion of the table comprising the first pre-equalizer parameter;
determining a convolution of the second pre-equalizer parameter with the first pre-equalizer parameter; and
adjusting the pre-equalizer based on the convolution.

2. The system of claim 1, wherein retrieving the portion of the table is based on the insertion loss of the port being within a threshold of the first insertion loss.

3. The system of claim 1, wherein the first insertion loss comprises an insertion loss range and wherein retrieving the portion of the table is based on the insertion loss being within the insertion loss range.

4. The system of claim 1, wherein the table further comprises a third pre-equalizer parameter for a second insertion loss.

5. The system of claim 1, wherein the operation further comprises communicating an instruction to the optical module indicating that the first pre-equalizer parameter was used.

6. The system of claim 5, wherein the table further comprises an optical module setting for the first insertion loss and wherein the optical module is configured to apply the optical module setting to the optical module based on the instruction from the host device.

7. The system of claim 1, wherein the insertion loss of the port is based on a length of a connection from the port to the one or more processors.

8. The system of claim 1, wherein the first insertion loss corresponds to a number of taps that is different from a number of taps of the pre-equalizer.

9. An optical module comprising:
one or more memories configured to, individually or collectively, store a table comprising a first pre-equalizer parameter for a first insertion loss; and
an interface configured to:
engage a port of a host device; and
direct, through the port and based on the first insertion loss, a portion of the table comprising the first pre-equalizer parameter and the first insertion loss such that the host device is configured to (i) perform a convolution using the first pre-equalizer parameter and a second pre-equalizer parameter and (ii) adjust a pre-equalizer of the host device based on the convolution.

10. The optical module of claim 9, wherein directing the portion of the table through the port is based on an insertion loss of the port being within a threshold of the first insertion loss.

11. The optical module of claim 10, wherein the insertion loss of the port is based on a length of a connection from the port to one or more processors of the host device.

12. The optical module of claim 9, wherein the first insertion loss comprises an insertion loss range and wherein directing the portion of the table through the port is based on an insertion loss of the port being within the insertion loss range.

13. The optical module of claim 9, wherein the table further comprises a third pre-equalizer parameter for a second insertion loss.

14. The optical module of claim 9, wherein the optical module further comprises one or more processors communicatively coupled to the one or more memories and wherein the one or more processors are configured to, individually or collectively, perform an operation comprising receiving an instruction from the host device indicating that the first pre-equalizer parameter was used.

15. The optical module of claim 14, wherein the table further comprises an optical module setting for the first insertion loss and wherein the operation further comprises applying the optical module setting to the optical module based on the instruction from the host device.

16. The optical module of claim 9, wherein the first insertion loss corresponds to a number of taps that is different from a number of taps of the pre-equalizer.

17. A host device comprising:
a port arranged to receive an optical module;
a pre-equalizer;
one or more memories configured to store a first pre-equalizer parameter for the pre-equalizer; and
one or more processors communicatively coupled to the one or more memories, wherein the one or more processors are configured to, individually or collectively, perform an operation comprising:
retrieving, from the optical module and based on an insertion loss of the port, a second pre-equalizer parameter;
determining a convolution of the first pre-equalizer parameter with the second pre-equalizer parameter; and
adjusting the pre-equalizer based on the convolution.

18. The host device of claim 17, wherein the retrieving the second pre-equalizer parameter comprises retrieving a portion of a table based on the insertion loss of the port being within a threshold of an insertion loss indicated by the portion of the table.

19. The host device of claim 17, wherein the retrieving the second pre-equalizer parameter comprises retrieving a portion of a table based on the insertion loss being within an insertion loss range indicated by the portion of the table.

20. The host device of claim 17, wherein the operation further comprises communicating an instruction to the optical module indicating that the first pre-equalizer parameter was used.
